(19) United States
(12) Patent Application Publication
(10) Pub. No.: US 2009/0071702 A1
(43) Pub. Date: Mar. 19, 2009

(54) CIRCUIT BOARD

(75) Inventors: YU-HSU LIN, San Jose, CA (US); WANG-JIA CHEN, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD ., Shenzhen City (TW); HON HAI PRECISION INDUSTRY CO., LTD., Taipei Hsien (TW)

(21) Appl. No.: 11/869,758

(22) Filed: Oct. 10, 2007

(30) Foreign Application Priority Data
Sep. 13, 2007 (CN) 200710201681.8

(51) Int. Cl. H01R 12/02

(52) U.S. Cl. 174/261

(57) ABSTRACT

A circuit board (10) for reducing a variation in impedance of signal traces thereon includes a first signal plane (30) and a second signal plane (50). The first signal plane includes a first signal trace (31) arranged thereon. The first signal trace has a first width. The second signal plane includes a plurality of second signal traces (51) arranged thereon. An orthographic projection of the first signal trace onto the second signal plane crosses the second signal traces. A width of the first signal trace at positions where the orthographic projection thereof onto the second signal plane at the intersections with the second signal traces transitions to a second width less than the first width of the first signal trace.

### BACKGROUND

1. Field of the Invention

The present invention relates to circuit boards, and more particularly to a circuit board with a signal trace having a proper variation in impedance thereof.

2. Description of Related Art

Circuit boards, such as printed circuit boards (PCBs) are widely used in conventional electronic devices, for mounting electronic components of the electronic devices thereon and supplying electric connections among the electronic components. To achieve compactness of the PCB, electronic devices have become more complicated. Thereby it is important to ensure the signal quality of the circuit board.

FIG. 1 shows a configurable view of signal traces of a conventional circuit board 10′, which has a signal trace 11′ and a plurality of signal traces 13′ arranged on two different signal planes of the circuit board 10′ respectively. Widths of the signal trace 11′ and the signal traces 13′ are uniform. At positions where an orthographic projection of the signal trace 11′ crosses the signal traces 13′, the impedance of the signal trace 11′ will be reduced too much. For example, an original width of the signal trace 11′ is 5 mil (1 mil=0.0254 mm), if where the orthographic projection of the signal trace 11′ crosses the signal traces 13′ is perpendicular, the impedance of the signal trace 11′ will be reduced by 8.4 ohms from 52.2 ohms to 43.8 ohms; if the orthographic projection of the signal trace 11′ crosses the signal traces 13′ at an angle of 45 degrees, the impedance of the signal trace 11′ will be reduced by 7.9 ohms from 52.2 ohms to 44.3 ohms. The large variations in impedance may affect the signal quality of the circuit board 10′.

What is needed, therefore, is a circuit board having a smaller variation in impedance of a signal trace for improving signal quality.

### SUMMARY

A circuit board for reducing a variation in impedance of signal traces thereon includes a first signal plane and a second signal plane. The first signal plane includes a first signal trace arranged thereon. The first signal trace has a first width. The second signal plane includes a plurality of second signal traces arranged thereon. An orthographic projection of the first signal trace onto the second signal plane crosses the second signal traces. A width of the first signal trace at positions where the orthographic projection thereof onto the second signal plane at the intersections with the second signal traces transitions to a second width less than the first width of the first signal trace.

Other advantages and novel features of the present invention will become more apparent from the following detailed description of a preferred embodiment when taken in conjunction with the accompanying drawings, in which:

### BRIEF DESCRIPTION OF THE DRAWINGS

FIG. 1 is a view of signal trace configuration of a conventional circuit board;

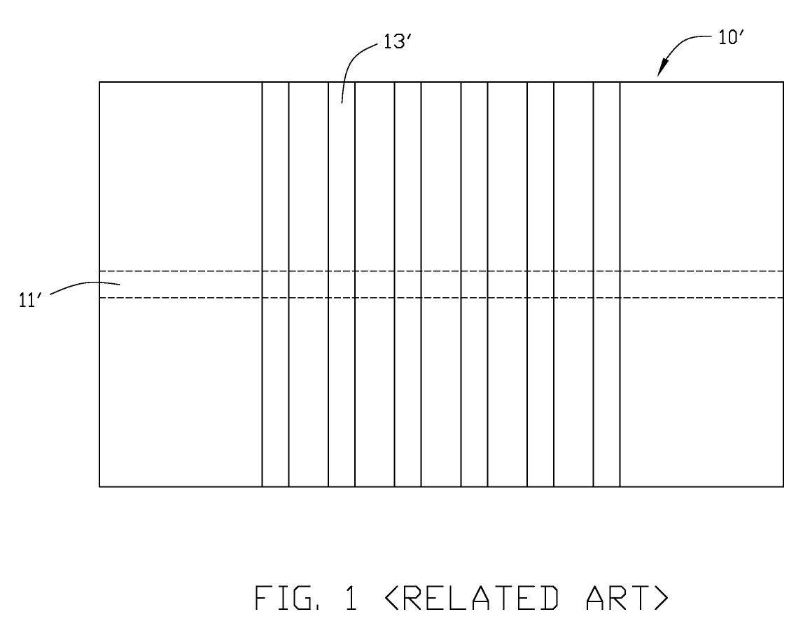

FIG. 2 is a schematic view of a circuit board in accordance with an embodiment of the present invention;

FIG. 3 is a view of signal trace configuration of the circuit board of FIG. 2; and

FIG. 4 is a view of signal trace configuration in another embodiment of the circuit board of FIG. 2.

### DETAILED DESCRIPTION

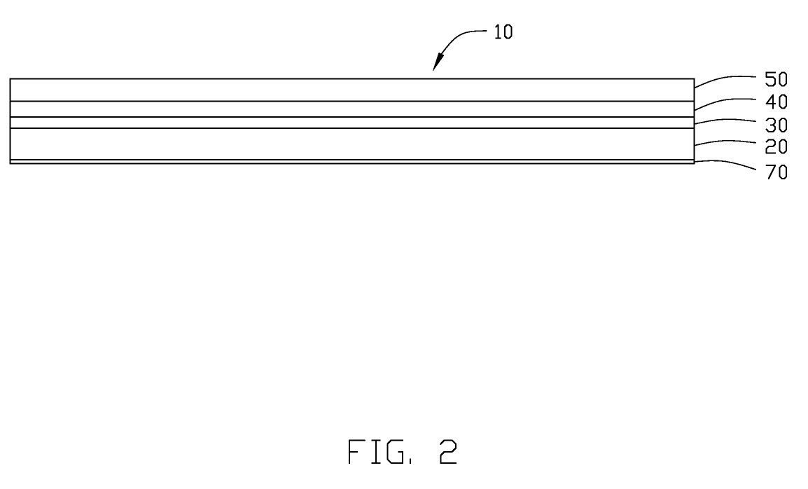

Referring to FIG. 2, a circuit board 10 of an embodiment of the present invention includes a ground plane 70, a first media plane 20, a first signal plane 30, a second media plane 40, and a second signal plane 50. The first media plane 20 is disposed between the ground plane 70 and the first signal plane 30, and the second media plane 40 is disposed between the first signal plane 30 and the second signal plane 50.

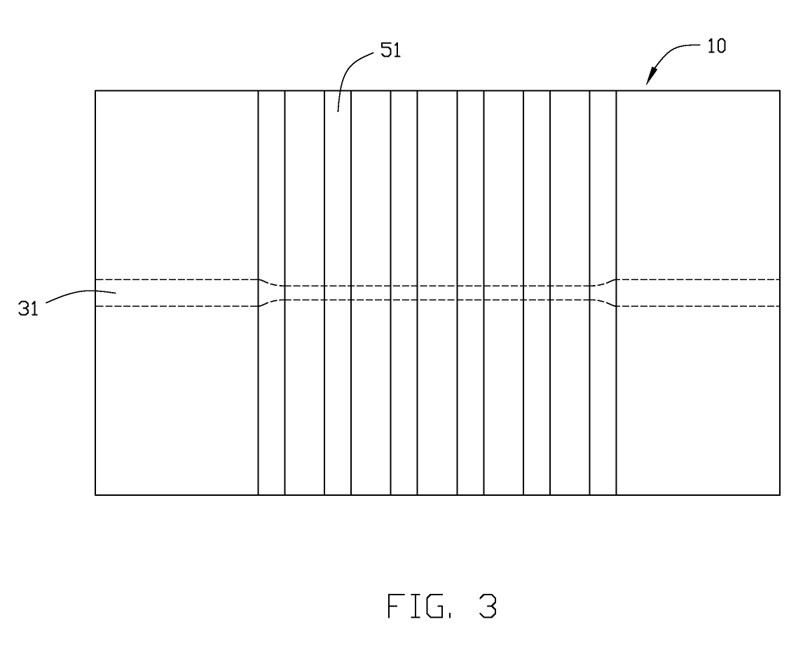

Referring also to FIG. 3, a first signal trace 31 is arranged on the first signal plane 30 for transmitting signals. A plurality of parallel second signal traces 51 is arranged in an area on the second signal plane 50 at regular intervals for transmitting signals. The first signal trace 31 has a first width. An orthographic projection of the first signal trace 31 on the second signal plane 50 crosses each of the second signal traces 51 perpendicularly. The width of the first signal trace 31 transitions to a narrower second width near or at the point where the projection enters the area of the seconds signal traces 51 and transitions back to the first width near or at the point where the projection leaves the area of the second signal traces 51.

For example, if the first width of the first signal trace 31 is 5 mil (1 mil=0.0254 mm), the impedance of the first signal trace 31 is 52.2 ohms. In this embodiment, if the width of the first signal trace 31 where its projection crosses the second signal traces 51 is reduced to 4 mil, the impedance of the first signal trace 31 will be reduced to 48.2 ohms, a reduction of only 4 ohms, thereby ensuring better signal quality of the circuit board 10.

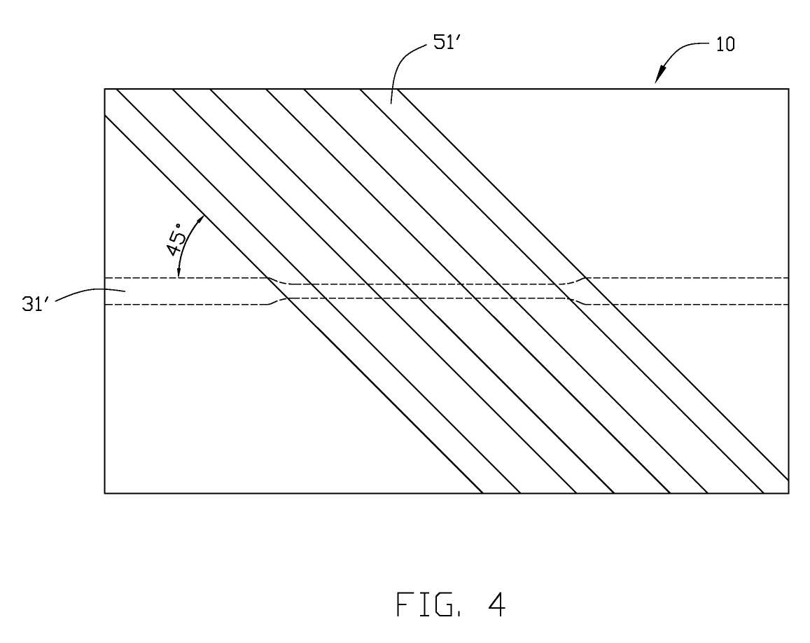

Referring to FIG. 4, this embodiment is similar to the first embodiment except that second signal traces 51′ are turned so that an orthographic projection of a first signal trace 31′ crosses the second signal traces 51′ at a 45 degrees angle.

As in the first embodiment, if a first width of the first signal trace 31′ is 5 mil, the impedance of the first signal trace 31′ is 52.2 ohms, and the width of the first signal trace 31′ transitions to 4 mil, as before, the impedance is reduced to 48.8 ohms. In this embodiment the reduction is only 3.4 ohms. Thus, ensuring the signal quality of the circuit board 10.

It should be noted that the transitions between the first and second widths of the embodiments are gradually but can varied according to need in other embodiments.

According to the above, when an orthographic projection of one signal trace onto another signal plane of the circuit board 10 crosses the signal traces arranged on the other signal plane at an angle of 90 degrees or 45 degrees, a width of the one signal trace will be reduced, thereby decreasing the variation in impedance of the one signal trace to ensure the signal quality of the circuit board 10.

Wherein the first and second signal traces 31, 31′, 51, 51′ can be arranged on different signal planes of the circuit board 10 respectively. In addition, when the orthographic projection of one signal trace onto another signal plane crosses the signal traces arranged on the other signal plane at other angles, particularly from 30 degrees to 90 degrees, the width of the one signal trace may be reduced to improve the variation in impedance of the one signal trace, thereby ensuring the signal quality of the circuit board.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A circuit board comprising:
a first signal plane comprising a first signal trace arranged thereon, the first signal trace having a first width; and
a second signal plane comprising a plurality of second signal traces arranged thereon, an orthographic projection of the first signal trace onto the second signal plane crossing the second signal traces, wherein a width of the first signal trace at positions where the orthographic projection thereof onto the second signal plane at the intersections with the second signal traces transitions to a second width less than the first width of the first signal trace.

2. The circuit board as described in claim 1, wherein a width of the first signal trace at positions where the orthographic projection on the second signal plane between two adjacent second signal traces is equal to the second width.

3. The circuit board as described in claim 2, wherein the orthographic projection of the first signal trace onto the second signal plane crosses the second signal traces at an angle from 30 degrees to 90 degrees.

4. The circuit board as described in claim 1, wherein a media plane is disposed between the first signal plane and the second plane.

5. A circuit board comprising:
a first signal plane having a first signal trace arranged thereon; and
a second signal plane having a plurality of second signal traces arranged thereon, an orthographic projection of the first signal trace onto the second signal plane crossing the second signal traces, a width of the segments of the first signal trace corresponding to where the orthographic projection falls on the second signal plane at the intersections with each second signal trace being equal to that of where the orthographic projection of other segments of the first signal trace fall on the second signal plane between two adjacent second signal traces, and being less than a width of the remaining segments of the first signal trace.

6. The circuit board as claimed in claim 5, wherein the orthographic projection of the first signal trace onto the second signal plane crosses the second signal traces at an angle from 30 degrees to 90 degrees.

7. The circuit board as claimed in claim 5, wherein a media plane is disposed between the first signal plane and the second plane.

8. The circuit board as claimed in claim 5, wherein the plurality of second signal traces is arranged on the second signal plane at regular intervals, and parallel to each other.

9. The circuit board as claimed in claim 5, wherein the width of the first signal trace transitions gradually between segments of different widths.

10. A circuit board comprising:
a dielectric layer;
a first circuit layer formed on the dielectric layer, the first circuit layer having a first signal trace, the first signal trace having a first portion having a first width, and a second portion having a second width, the second width being less than the first width; and
a second circuit layer formed on an opposite side of the dielectric layer to the first circuit layer, the second circuit layer having a plurality of second signal traces, an orthographic projection of the second portion of the first signal trace onto a main plane of the second circuit layer intersecting the second signal traces.

11. The circuit board as claimed in claim 10, wherein a width of the joint section between the first and second portions of the first signal trace progressively increases from the second portion to the first portion.

12. The circuit board as claimed in claim 10, wherein the orthographic projection of second portion of the first signal trace onto the second signal plane intersects the second signal traces at an angle in the range from 30 degrees to 90 degrees.
